(19) United States
(12) Patent Application Publication
(10) Pub. No.: US 2016/0266622 A1
(43) Pub. Date: Sep. 15, 2016

(54) Mobile Terminal Heat Dissipation Apparatus and Shielding Cover Frame

(71) Applicant: ZTE CORPORATION, Shenzhen, Guangdong (CN)

(72) Inventors: Kai ZHAO, Shenzhen (CN); Fangxi HOU, Shenzhen (CN)

(21) Appl. No.: 15/036,815

(22) PCT Filed: Aug. 20, 2014
(86) PCT No.: PCT/CN2014/084863

§ 371 Date: May 16, 2016

(30) Foreign Application Priority Data
Nov. 19, 2013 (CN) 201320732204.5

(51) Int. Cl. G06F 1/20; G06F 1/16

(52) U.S. Cl. CPC G06F 1/203; G06F 1/1656

(57) ABSTRACT

A mobile terminal heat dissipation apparatus and a shielding cover frame (102) relate to the field of mobile terminal heat dissipation and shielding. The mobile terminal heat dissipation apparatus includes the printed circuit board (101) and the shielding cover frame (102) set on the printed circuit board (101), and the printed circuit board (101) includes multiple heat source chips (106, 107, 108 and 109); and a cavity structure for accommodating the multiple heat source chips (106, 107, 108 and 109) is formed between the shielding cover frame (102) and the printed circuit board (101). The shielding cover frame (102) is a cavity structure that is open at one end, and the cavity structure is set to accommodate the multiple heat source chips (106, 107, 108 and 109).

### TECHNICAL FIELD

The present document relates to the field of mobile terminal heat dissipation and shielding, and particularly, to a mobile terminal heat dissipation apparatus and a shielding cover frame.

### BACKGROUND OF THE RELATED ART

With the development of the mobile electronic device technology and mobile Internet, the functions and performance of the mobile terminals have gradually approached or converged to the computers, especially with the rapid development of the smartphone industry, the frequency of the main chip CPU within the terminal is higher and higher, and the number of cores of the CPU gradually evolves from a single core to dual cores, four cores and even eight cores, and the amount of data exchange between the terminal mobile phone and the network is also sharply increased, which greatly increases the power consumption of each chip in the terminal device. The increase of the power consumption brings the heating problem of the terminal device, and it is hard to add a fan for cooling in the mobile terminal onto the CPU like on the computer at present, thus a contradiction is formed between the heating and the normal use of the terminal.

At present, the heat conduction way of the mobile terminal heat dissipation is mainly to add a large-area copper foil laminating zone or graphite flake zone inside the case surface of the mobile terminal (such as inside the rear battery cover and inside the battery compartment case). With the characteristics of high lateral thermal conductivity of the copper foil and the graphite flake, the heat dissipation surface area of the case is increased for cooling. The key problem of the heat conduction way is to transfer the heat within heat source chips to the outside surface of the case quickly in low thermal resistance, thus it is beneficial to transfer the heat to the low-temperature zone of the outside surface from the high-temperature zone within the machine.

As shown in FIG. 1, the traditional heat conduction way is to split the main chips and surrounding related circuits by cavity dividing for shielding in a form of shielding cover frames on a PCB board, but subject to factors of component layout and shielding cover frame processing technology, sizes of the traditional discrete style shielding cover frames are all smaller. Due to cavity dividing within the smaller shielding cover frames, it causes that the air convection effect within the heat source chips is very poor, and materials of the shielding cover frames are normally steel discs, the thermal conductivity of the steel discs is lower, thus the heat cannot be effectively transferred to the low-temperature zone of the outside surface of the case from the high-temperature zone of the heat source chips, and the heat dissipation effect is bad.

### SUMMARY

The technical problem required to be solved in the embodiments is to provide a mobile terminal heat dissipation apparatus and a shielding cover frame, thus heat generated by heat source chips on a PCB board is transferred to an outside surface of a case quickly and in a large area for heat dissipation.

In order to solve the above problem, the embodiment of the present document provides a mobile terminal heat dissipation apparatus, which comprises: a printed circuit board and a shielding cover frame set on the printed circuit board, wherein the printed circuit board comprises a plurality of heat source chips; and

a cavity structure for accommodating the plurality of heat source chips is formed between the shielding cover frame and the printed circuit board.

Alternatively, the shielding cover frame comprises a sealing edge, and the shielding cover frame is withheld on the printed circuit board through the sealing edge.

Alternatively, the shielding cover frame is a magnalium shielding cover frame.

Alternatively, the sealing edge of the shielding cover frame is a contact spring.

Alternatively, the contact spring is a zigzag contact spring.

Alternatively, the sealing edge of the shielding cover frame is a conductive foam gasket or a snap joint.

Alternatively, the heat source chip is a master chip cpu, a power management chip, a memory chip or an LCD backlight chip.

In order to solve the above problem, the embodiment of the present document further provides a shielding cover frame, which is a cavity structure that is open at one end, wherein the cavity structure is configured to accommodate a plurality of heat source chips.

Alternatively, the shielding cover frame comprises a sealing edge.

Alternatively, the sealing edge is a contact spring or a conductive foam gasket or a snap joint.

In conclusion, the shielding cover frame of the embodiment of the present document uses an one-piece heat dissipation scheme, and a large-cavity shielding cover frame is made by using a large frame of metal support, so that main heat source component live load chips such as a master chip CPU, each power management chip, a memory chip or an LCD backlight chip and so on are all in a larger shielding cavity, which enhances the air flow within the cavity, enlarges the heat conduction planarization area, facilitates the heat dissipation, and improves the heat dissipation effect.

### BRIEF DESCRIPTION OF DRAWINGS

FIG. 1 is a schematic diagram of a structure of the existing mobile terminal shielding cover frame;

FIG. 2 is a schematic diagram of a structure of a mobile terminal heat dissipation apparatus according to the embodiment of the present document;

FIG. 3 is a side view of the sealing edge of the shielding cover frame according to one embodiment of the present document;

FIG. 4 is a schematic diagram of a structure of the sealing edge of the shielding cover frame according to one embodiment of the present document.

### PREFERRED EMBODIMENTS

In order to make the object, technical scheme and advantages of the present document more clear, the embodiments of the present document will be described in detail in combination with the accompanying drawings below. It should be noted that the embodiments and the characteristics in the embodiments in the present document can be arbitrarily combined with each other in the case of no conflict.

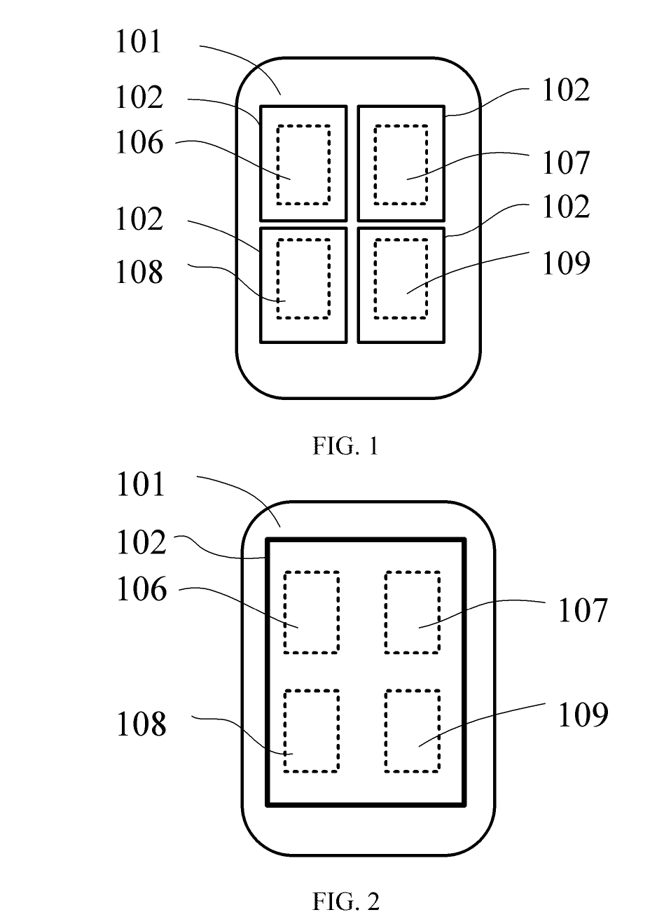

FIG. 2 is a schematic diagram of a structure of a mobile terminal heat dissipation apparatus according to the embodiment of the present document. As shown in FIG. 2, a mobile terminal heat dissipation apparatus of the embodiment of the present document includes: a Printed Circuit Board PCB101 and a shielding cover frame 102 set on the printed circuit board, and the printed circuit board includes multiple heat source chips 106, 107, 108 and 109; and

a cavity structure for accommodating the multiple heat source chips 106, 107, 108 and 109 is formed between the shielding cover frame 102 and the printed circuit board 101.

With regard to a fixed support normally using the metal support as a structure case in the mobile terminals such as a mobile phone, the shielding cover frame 102 can be processed to be a cavity structure open at one end based on the original metal support in the embodiment of the present document, the cavity structure can accommodate the multiple heat source chips 106, 107, 108 and 109, the shielding cover frame 102 is withheld on the printed circuit board 101 to form a shielding area that defends the external electromagnetic interference. In the shielding cover frame 102, compared with the traditional discrete style shielding cover frame, the wall body part is greatly enlarged, so that the hot air convection capacity within the entire large cavity is enhanced greatly, and the heat generated by the heat source chips 106, 107, 108 and 109 can be transferred quickly in planarizartion.

Preferably, the shielding cover frame 102 includes a sealing edge, and the shielding cover frame is withheld on the printed circuit board 101 through the sealing edge.

In order to enhance the anti-electromagnetic interference sealed shielding performance of the shielding cover frame 102, the shielding cover frame includes a sealing edge, and reliable grounding processing is performed through the sealing edge.

The shielding cover frame is a metal cover frame, and a magnalium shielding cover frame is preferably selected in the embodiment of the present document.

The thermal conductivity of the magnalium is far higher than that of the traditional steel disc materials, thus the heat within the cavity can be transferred to the outside of the shielding cover frame quickly in low thermal resistance until it is transferred to the outside of the case of the terminal, which has an excellent heat dissipation effect.

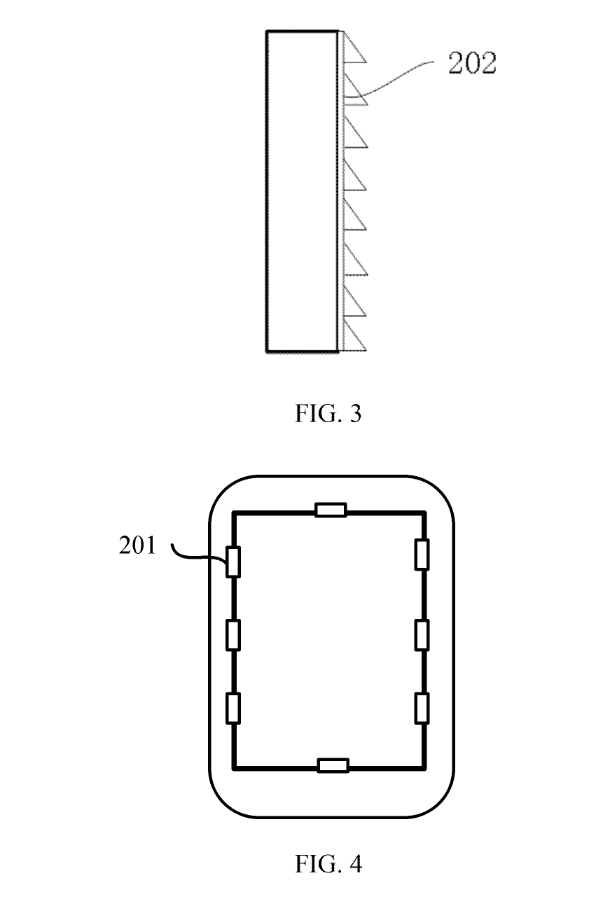

As shown in FIG. 3 to FIG. 4, the sealing edge of the shielding cover frame 102 is a contact spring 202 or a conductive foam gasket or a snap joint 201.

When the sealing edge is the contact spring 202, a zigzag contact spring 202 is preferably selected in the embodiment of the present document.

The heat source chips 106, 107, 108 and 109 include but are not limited to a master chip cpu, a power management chip, a memory chip or a Liquid Crystal Display (LCD) backlight chip.

### Embodiment 1

FIG. 3 is a side view of the sealing edge of the shielding cover frame according to one embodiment of the present document. As shown in FIG. 3, the sealing edge is a zigzag contact spring 202, a structure of the zigzag contact spring 202 is fixed on the edge of the shielding cover frame 102, and the spring is normally copper materials. When the shielding cover frame 102 is fixedly pressured and jointed onto the mainboard PCB101, the zigzag contact spring 202 is fully contacted with the mainboard, which has an excellent sealed grounding effect. Since the thermal conductivity of the copper materials of the zigzag contact spring 202 is very high, the spring is beneficial to conducting the heat on the mainboard to the shielding cover frame 102, which plays a good heat dissipation effect.

Wherein, the length and width of the shielding cover frame 102 is decided by the mainboard and the component layout structure, which can be any size and shape and not limited to a cuboid. Generally the thickness of the cavity of the shielding cover frame 102 is between 1.2 mm˜2.0 mm.

### Embodiment 2

FIG. 4 is a schematic diagram of a structure of the sealing edge of the shielding cover frame according to one embodiment of the present document. As shown in FIG. 4, a conductive foam gasket or a metal snap joint 201 is designed on the contact track between the shielding cover frame 102 and the mainboard PCB101, thus when the shielding cover frame 102 is withheld on the mainboard PCB101, the grounding effect of the shielding cover frame 102 and the mainboard PCB101 can be better enhanced through the conductive foam gasket 201, thereby ensuring the shielding effect. Or when the shielding cover frame 102 is withheld with the mainboard PCB101, the shielding cover frame and the mainboard are connected through the metal snap joint 201, which similarly enhances the grounding effect and assembly firmness.

In the embodiments of the present document, due to the metal characteristics of the shielding cover frame 102 itself, it can serve as the characteristics of excellent anti-electromagnetic interference, the grounding structure of the zigzag contact spring 202 enhances the shielding effect of grounding. In addition, the cavity of the shielding cover frame 102 of the embodiment of the present document has no space limitations, the freedom degree of component layout on the mainboard is very high, the space heat convection capacity is strong, and thus a very ideal terminal heat dissipation effect can be achieved.

The above embodiments are only used to describe the technical scheme of the present document, which does not limit the technical scheme of the present document. The present document is just described in detail with reference to the preferred embodiments. The ordinary person skilled in the art should understand that, with regard to the technical scheme of the present document, modifications or equivalent substitutions can be made without departing from the essence and scope of the technical scheme of the present document, and all these modifications and equivalent substitutions should be covered within the scope of the claims of the present document.

### INDUSTRIAL APPLICABILITY

A mobile terminal heat dissipation apparatus and a shielding cover frame relate to the field of mobile terminal heat dissipation and shielding, thus heat generated by heat source chips on a PCB board is transferred to an outside surface of a case quickly and in a large area for heat dissipation. A printed circuit board and a shielding cover frame set on the printed circuit board are included, the printed circuit board includes multiple heat source chips, and a cavity structure for accommodating the multiple heat source chips is formed between the shielding cover frame and the printed circuit board, which can enhance the air flow within the cavity, enlarge the heat conduction planarization area, and improve the heat dissipation effect.

What is claimed is:

1. A mobile terminal heat dissipation apparatus, comprising: a printed circuit board and a shielding cover frame set on the printed circuit board, wherein the printed circuit board comprises a plurality of heat source chips; and
a cavity structure for accommodating the plurality of heat source chips is formed between the shielding cover frame and the printed circuit board.

2. The apparatus of claim 1, wherein, the shielding cover frame comprises a sealing edge, and the shielding cover frame is withheld on the printed circuit board through the sealing edge.

3. The apparatus of claim 1, wherein, the shielding cover frame is a magnalium shielding cover frame.

4. The apparatus of claim 2, wherein, the sealing edge of the shielding cover frame is a contact spring.

5. The apparatus of claim 4, wherein, the contact spring is a zigzag contact spring.

6. The apparatus of claim 2, wherein, the sealing edge of the shielding cover frame is a conductive foam gasket or a snap joint.

7. The apparatus of claim 1, wherein, the heat source chip is a master chip CPU, a power management chip, a memory chip or an LCD backlight chip.

8. A shielding cover frame, characterized in that the shielding cover frame is a cavity structure that is open at one end, the cavity structure is configured to accommodate a plurality of heat source chips.

9. The shielding cover frame of claim 8, wherein, the shielding cover frame comprises a sealing edge.

10. The shielding cover frame of claim 9, wherein, the sealing edge is a contact spring or a conductive foam gasket or a snap joint.

11. The shielding cover frame of claim 8, wherein, the shielding cover frame is of magnalium.

12. The shielding cover frame of claim 9, wherein, the sealing edge of the shielding cover frame is a contact spring.

13. The shielding cover frame of claim 12, wherein, the contact spring is a zigzag contact spring.
